(19) United States
(12) Patent Application Publication
(10) Pub. No.: US 2005/0213682 A1
(43) Pub. Date: Sep. 29, 2005

(54) Apparatus and method for transmitting and receiving data in a mobile communication system using an array antenna

(75) Inventors: Jin-Kyu Han, Suwon-si (KR); Dae-Gyun Kim, Seongnam-si (KR); Hwan-Joon Kwon, Suwon-si (KR); Dong-Hee Kim, Seoul (KR); Youn-Sun Kim, Seongnam-si (KR); Han-Kyu Park, Seoul (KR); Cheol Mun, Suwon-si (KR); Myoung-Won Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Gyeonggi-do (KR)

(21) Appl. No.: 11/074,196

(22) Filed: Mar. 7, 2005

(30) Foreign Application Priority Data
Mar. 5, 2004 (KR) 15223/2004

(51) Int. Cl. H04L 1/02

(52) U.S. Cl. 375/267; 375/299

(57) ABSTRACT

An apparatus and a method for transmitting and receiving data in a mobile communication system including an array antenna. The method includes the steps of transmitting pilot channels through a transmission antenna while aligning the pilot channels orthogonally to each other, receiving feedback information related to the pilot channels from a mobile station capable of receiving the data, dividing the data to be transmitted into sub-data streams by using the feedback information, and determining a coding rate and a transmit power for the sub-data streams, and converting the sub-data streams into symbol arrays to be transmitted according to the coding rate and the transmit power and transmitting data by converting the data into fixed beams.

### PRIORITY

This application claims priority to an application entitled “Apparatus and Method for Transmitting/Receiving Data in Mobile Communication System using Array Antenna” filed in the Korean Intellectual Property Office on Mar. 5, 2004 and assigned Serial No. 2004-15223, the contents of which are incorporated herein by reference.

### BACKGROUND OF THE INVENTION

1. Field of the Invention

The present invention relates generally to an apparatus and a method for transmitting and receiving data in a mobile communication system including an array antenna, and more particularly to an apparatus and a method for transmitting and receiving data in a mobile communication system using an array antenna, which enables transmission and reception of data to be adaptively performed according to channel conditions having various temporal and spatial correlations.

2. Description of the Related Art

Recently, an initial mobile communication system, which was originally designed for providing a voice-centered service, has developed into a wireless data packet communication system that provides a data service and a multimedia service of a high quality at a high speed. Current standardization for a High Speed Downlink Packet Access (HSDPA) and a 1×EV-DV based mainly by a 3^{rd} Generation Partnership Project (GPP) and a 3GPP2 is a representative effort for providing a high quality wireless data packet transmission service of high speed more than 2 Mbps in a 3G mobile communication system. Further, a 4G mobile communication system has been developed with the hopes of providing a high quality multimedia service at a speed higher than that of the 3G mobile communication system.

Further, in order to provide a high quality data service at a high speed in a wireless communication, a Multiple-Input Multiple-Output (MIMO) antenna system using multiple antennas in a transmission side and a reception side has been proposed. Theoretically, in a MIMO antenna system, the data capacity capable of being provided will linearly increase in proportional to the number of transmission/reception antennas without increasing an additional frequency bandwidth.

More specifically, the MIMO antenna system provides high data capacity in proportion to the number of transmission/reception antennas, when a fading between the transmission/reception antennas is independent. However, the MIMO antenna system provides considerably reduced data capacity in environments including a high spatial correlation of a fading, as compared with in the environments including independent fading because fading experienced by signals transmitted from each transmission antenna is similar when the correlation of the fading between the transmission/reception antennas increases, such that it is difficult for a reception side to spatially distinguish the signals from each other. Therefore, interference between the signals transmitted from each transmission antenna increases and a symbol estimation error increases, thereby reducing the transmission data capacity.

In order to obtain an independent fading characteristic between transmission/reception antennas in mobile communication environments, an antenna interval between the transmission/reception antennas must be more than four wavelengths. However, because this requirement cannot be satisfied in a small terminal receiver or a base station system using many transmission antennas, transmission capacity may be reduced due to a spatial correlation of fading.

The MIMO antenna system using a MIMO scheme simultaneously transmits multiple data streams through multiple transmission antennas. When the multiple data streams are simultaneously transmitted, a receiver requires a scheme for distinguishing the multiple transmission data streams from each other and restoring the data streams. A Vertical Bell Laboratories Space-Time (V-BLAST) scheme proposed by Bell Laboratories has been proposed as one representative scheme.

In the V-BLAST multiple data reception scheme, a receiver sequentially estimates symbols of each data stream and removes portions caused by symbols already estimated from received signals, thereby canceling interference caused by the previously estimated symbols in the next symbol estimation. The series of continuous estimation and interference cancellation processes are repeated until all data streams are restored. In the data reception scheme, when the first symbol estimation is incorrect, an error occurs in the interference cancellation process for the next symbol, so that an error occurs in the next symbol estimation. This is referred to as error propagation. Capacity reduction due to this error propagation frequently occurs in fading channel environments having high spatial correlation.

According to recent research, in environments having a high spatial correlation of a fading or environments having a low Signal to Interference plus Noise Ratio (SINR), transmission of a single data stream using a beam forming has the same transmission capacity as that in simultaneous transmission of multiple data stream by a MIMO antenna system.

In considering an imperfect interference cancellation between multiple data stream or an error propagation occurring in an actual operation, a single data stream transmission scheme based on the beam forming transmits higher data capacity. Accordingly, in environments having a low spatial correlation and a high SINR, a scheme of simultaneously transmitting multiple data stream by means of a MIMO antenna system transmits higher data capacity. In contrast, in environments having a high spatial correlation and a low SINR, a scheme of transmitting a single data stream using the beam forming transmits higher data capacity.

Consequently, it is necessary to provide a MIMO antenna technology for use in a MIMO system capable of simultaneously transmitting multiple data or adaptable for a beam-forming system capable of transmitting single data according to a spatial correlation and an average SINR of channel environments.

### SUMMARY OF THE INVENTION

Accordingly, the present invention has been designed to solve the above and other problems occurring in the prior art. An object of the present invention is to provide an apparatus and a method for transmitting and receiving data in a mobile communication system using an array antenna, which can maximize the capacity of multiple antenna systems while minimizing influence of the Doppler effect caused by the movement of a terminal and a spatial correlation of a fading between antennas, when spatial multiple transmission is performed by means of the mobile communication system including multiple antennas.

In accordance with one aspect of the present invention, there is provided a method of transmitting data by dividing the data into sub-data streams in a mobile communication system having a multiple array antenna. The method includes the steps of: transmitting pilot channels through a transmission antenna while aligning the pilot channels orthogonally to each other; receiving feedback information related to the pilot channels from a mobile station capable of receiving the data, dividing the data to be transmitted into sub-data streams by using the feedback information, determining a coding rate and a transmit power for the sub-data streams, converting the sub-data streams into symbol arrays to be transmitted according to the coding rate and the transmit power, and transmitting data by converting the data into fixed beams.

In accordance with another aspect of the present invention, there is provided a method of receiving data, which is transmitted while being divided into sub-data streams, in a mobile communication system having a multiple array antenna. The method includes the steps of: estimating a state of each sub-channel established by a multiple antenna of a transmitter and feeding back information related to the state of the sub-channel; determining a decoding order of data streams received in each of sub-channels; sequentially decoding the data streams according to the decoding order while removing interference of decoded data streams to the data streams being decoded; and multiplexing the sub-data streams into a main data stream when a decoding process for the data streams has been completed.

In accordance with further another aspect of the present invention, there is provided an apparatus for transmitting data by dividing the data into sub-data streams in a mobile communication system having a multiple array antenna. The apparatus includes: a controller for receiving feedback information related to the pilot channels from a mobile station capable of receiving the data, determining a number and a size of sub-data streams of the data to be transmitted by using the feedback information, and determining and outputting a coding rate and a transmit power for the sub-data streams; a demultiplexer for outputting the data to the mobile station by demultiplexing the data according to information related to the number and the size of the sub-data streams transmitted from the controller; a data processing unit for receiving the coding rate from the controller, converting the sub-data streams output from the demultiplexer into symbols to be transmitted, and outputting the symbols; a power allocating unit for receiving power allocation information from the controller, allocating power to each symbol transmitted thereto from the data processing unit, and outputting the symbols; and a fixed beam former performing a beam-forming process in order to convert the symbols output from the power allocating unit into predetermined beams.

In accordance with still another aspect of the present invention, there is provided an apparatus for receiving data, which are transmitted while being divided into sub-data streams, in a mobile communication system having a multiple array antenna. The apparatus includes: a fading estimator for estimating a fading of each sub-channel established by a multiple antenna of a transmitter; a channel state estimator for creating channel state information for each sub-data stream and feeding back the channel state information by using a signal output from the fading estimator; a linear coupler for outputting data by linearly combining sub-data streams received through a multiple antenna; a data processing unit for decoding sub-data streams, which are output from the linear coupler and in which interference is not removed; an interference remover for removing interference caused by decoded information based on information output from the data processing unit and fading estimator; and a data processing unit for decoding sub-data streams output from the interference remover.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating a PARC transmitter in a Code Division Multiplex Access (CDMA) mobile communication system including a transmission antenna array for spatial multiple transmission;

FIG. 2 is a block diagram illustrating a PSRC transmitter in a CDMA mobile communication system including a transmission antenna array for spatial multiple transmission;

FIG. 3 is a diagram illustrating one example of a beam pattern of a transmit weight matrix in a PCBRC system according to an embodiment of the present invention;

FIG. 4 is a block diagram illustrating a transmitter in a PCBRC system according to an embodiment of the present invention;

FIG. 5 is a block diagram illustrating a receiver in a PCBRC system according to an embodiment of the present invention;

FIGS. 6A and 6B are block diagrams illustrating the data demodulator in the receiver in FIG. 5 according to embodiments of the present invention; and

FIG. 7 is a block diagram illustrating a transmission and reception operation process of a PCBRC system according to an embodiment of the present invention.

### DETAILED DESCRIPTION OF THE PREFERRED EMBODIMENT

Preferred embodiments of the present invention will be described in detail herein below with reference to the accompanying drawings. In the following description of the present invention, a detailed description of known functions and configuration incorporated herein will be omitted when it may make the subject matter of the present invention rather unclear.

However, before a detailed description is given, the present invention proposes transmission and reception apparatus and method, which improves transmission capacity by forming orthogonal spatial sub-channels by weights commonly applied to all fixed mobile stations in a base station and controlling transmission rate and transmit power according to each substream based on state of each sub-channel including each transmitted data stream, when multiple data streams are transmitted using multiple transmission and reception antennas.

A representative MIMO antenna technology proposed up to now includes a Per Antenna Rate Control (PARC), a Per Stream Rate Control (PSRC), etc., proposed by a 3GPP standardizing a broadcast system. A technology proposed by the present invention, which will be described later, will be referred to as a Per Common Basis Rate Control (PCBRC).

In the PARC scheme, a plurality of data streams are simultaneously transmitted through multiple transmission antennas. Signals received in multiple reception antennas of a terminal receiver are distinguished according to the transmission antennas, such that a high peak data rate can be provided.

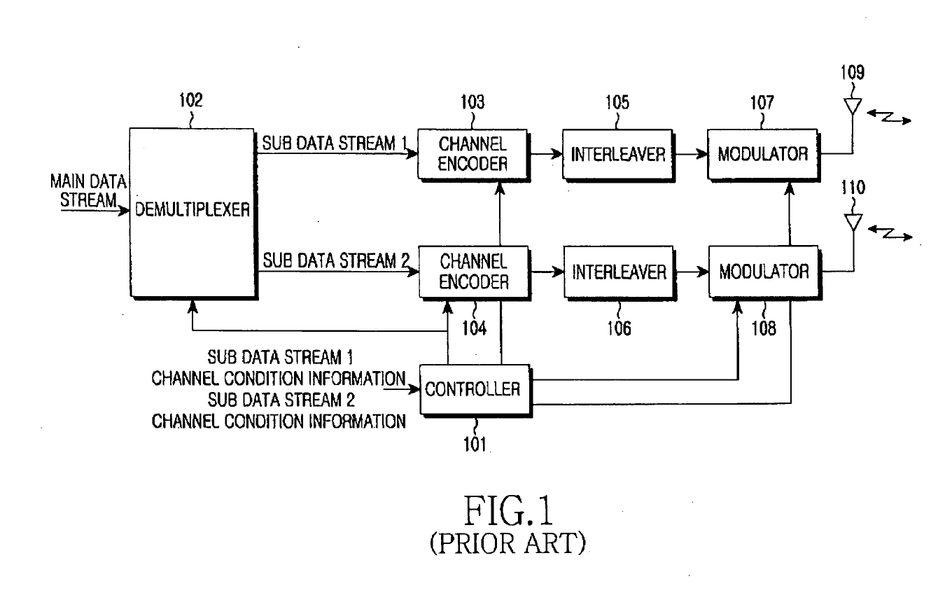

FIG. 1 is a block diagram illustrating a PARC transmitter in a CDMA mobile communication system including a transmission antenna array for spatial multiple transmission. More specifically, FIG. 1 illustrates a case including two transmission antennas and two reception antennas. However, only when the number of reception antennas is greater than or equal to the number of transmission antennas, is it possible to employ a plurality of transmission/reception antennas.

Referring to FIG. 1, a controller 101 determines a modulation scheme and a coding rate of each sub-data stream using channel condition information of each sub-data stream fedback from a receiver, and informs a demultiplexer 102, channel encoders 103 and 104, and modulators 107 and 108 of the determined modulation scheme and coding rate. In the PARC scheme, the channel condition information of each sub-data stream is the SINR of each transmission antenna estimated by the receiver.

The demultiplexer 102 distributes main data stream to be transmitted to sub-data streams by the number of transmission antennas. The sub-data streams are independently encoded by the channel encoders 103 and 104, are interleaved by interleavers 105 and 106, and are then mapped to symbols in the modulators 107 and 108. The mapped symbols, as describe above, are transmitted through antennas 109 and 110.

Herein, data rates in the transmission antennas are different from each other due to downlink channel conditions different according to the transmission antennas. Accordingly, the sub-data streams may have different coding rates and modulation schemes.

The receiver estimates SINRs according to the transmission antennas. A base station determines a maximum transmission rate according to each antenna, and determines a coding rate and a modulation scheme according to the maximum transmission rate, on the basis of the SINRs of downlink channels according to the transmission antennas.

The PARC scheme, as described above, is an open-loop scheme and does not need to transmit antenna scheme-related information from the receiver to the transmitter. Accordingly, the controller 101 receives only the condition information of each sub-data stream fedback from a mobile station, that is, the SINRs of the transmission antennas.

In a closed-loop scheme, which will be described later, each mobile station must feedback weighted vale information to a base station controller. Accordingly, because an open-loop multiple transmission/reception antenna scheme does not need to feedback weighted value information changing according to passage of time from the receiver to the transmitter, the open-loop multiple transmission/reception antenna scheme can provide high transmission capacity in rapidly changing fading environments as compared with a closed-loop multiple transmission/reception antenna scheme.

Further, recent research relating to the PARC scheme has proposed a scheme for transmitting data through only one antenna instead of simultaneously transmitting the data through multiple antennas in environments including a high spatial correlation of a fading. For example, when there are two transmission antennas, a combination having a maximum transmission rate is determined from among three combinations. The three combinations include a case in which only a first antenna transmits data, a case in which only a second antenna transmits data, and a case in which the first antenna and the second antenna simultaneously transmit data. When the two antennas simultaneously transmit sub-data streams, transmit power of each antenna is half of transmission antenna power required for single transmission. Further, transmission rates for the three cases are calculated and a case having a maximum transmission rate is selected.

However, because the PARC scheme, as described above, must calculate SINRs for all cases, the receiver requires large operation amount. Further, when the receiver uses a sequence estimation and interference cancellation scheme such as a V-BLAST, the receiver estimates a current symbol on an assumption that previous symbols have been completely estimated in an SINR calculation. Accordingly, in a transmission rate calculation step, multiple transmission has a transmission rate that is always greater than or equal to that of single transmission. However, when the multiple transmission is performed in environments including a high spatial correlation of a fading in actual data transmission, an initial symbol estimation error increases due to interference between simultaneously transmitted symbols, such that an error propagation may occur. Therefore, the multiple transmission may provide transmission capacity lower than that of the single transmission.

Hereinafter, a PSRC scheme for multiplying each sub-data stream by a weight selected by a terminal and transmitting the sub-data stream will be described.

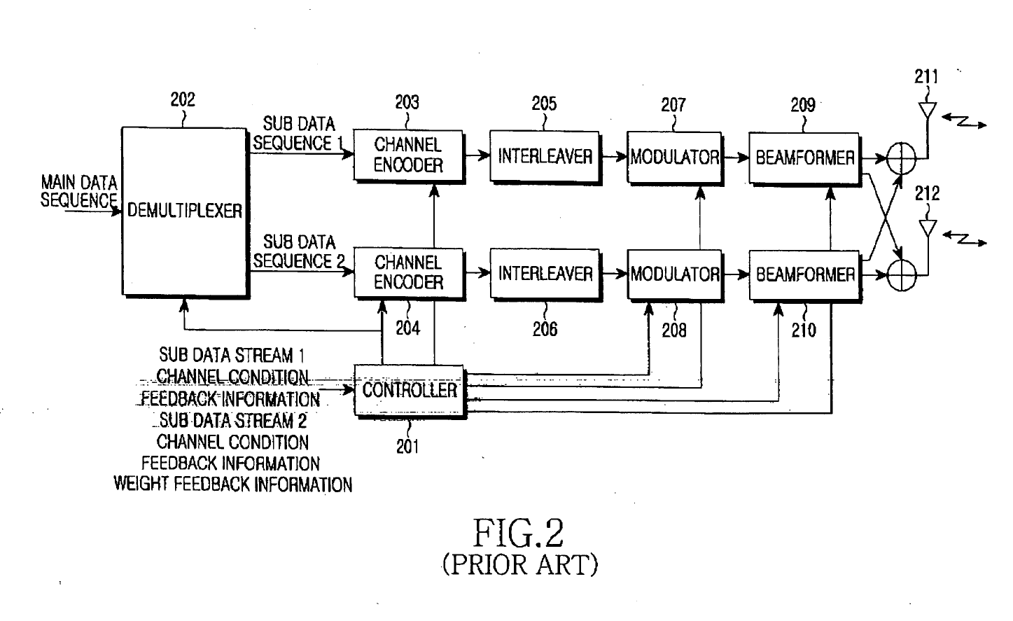

FIG. 2 is a block diagram illustrating a PSRC transmitter in a CDMA mobile communication system including a transmission antenna array for spatial multiple transmission. Referring to FIG. 2, a controller 201 determines a modulation scheme and a coding rate of each sub-data stream based on condition information and weight information of each sub-data stream fedback from a receiver, and informs a demultiplexer 202, channel encoders 203 and 204, and modulators 207 and 208 of the determined modulation scheme and coding rate. The controller 201 detects weights selected by the receiver for each stream to be transmitted and transmits the weights to beam formers 209 and 210. The demultiplexer 202 demultiplexes main data stream to be transmitted to sub-data streams by the number of transmission antennas. The sub-data streams are independently input in and encoded by the channel encoders 203 and 204, are interleaved by interleavers 205 and 206, and are then mapped to symbols in the modulators 207 and 208. The symbols of the sub-data streams are multiplied by corresponding weights in the beam formers 209 and 210 and are then transmitted. Herein, the coding rate and the modulation scheme of each sub-data stream are adjusted according to conditions of each channel through which a corresponding sub-data stream is to be transmitted though antennas 211 and 212.

Herein, the weights multiplied to the sub-data streams are determined by each receiver and fedback to a transmitter. When there are two transmission antennas, an i^{th} weight may be expressed by a weight matrix Wᵢ including two weight vectors as shown in Equation (1).

$${W}_{i} = [ {w}_{i , 1} {w}_{i , 2} ] = [ \begin{matrix}\sqrt{1 - {A}_{i}^{2}} & - {A}_{i} {ⅇ}^{- {ⅈθ}_{i}} \\ {A}_{i} {ⅇ}^{- {ⅈθ}_{i}} & \sqrt{1 - {A}_{i}^{2}}\end{matrix} ] \qquad ( 1 )$$

In Equation (1), Aᵢ and θᵢ represent the magnitude and the phase of an i^{th} weight, respectively. Herein, because w_{i,1} and w_{i,2} are theoretically orthogonal to each other, interference between the sub-data streams does not occur when w_{i,1} and w_{i,2} are simultaneously multiplied to the sub-data streams. However, because the magnitude and the phase of the weight matrix are generally quantized, it is impossible to completely prevent the interference between the sub-data streams.

The limited number of weight matrix sets is determined through quantization of the weight matrix. For example, when four bit feedback information is used, 16 weight matrices W₁ to W₁₆ are determined. The receiver determines an index i (i=1, . . . , 16) of a weight having a maximum transmission rate by means of a downward fading estimated value and a predetermined weight matrix set, and feedbacks the index to a base station. Herein, because the fading changes over time, a step for determining the weight must be repeated at each time slot. Further, the weight matrix index determined through the step must be fedback to the transmitter each time slot. Accordingly, the PSRC scheme is a closed-loop scheme, in contrast with the PARC scheme, and the receiver transmits the weight index having the maximum transmission rate to a transmitter controller 111 at each time slot.

In the closed-loop scheme such as the PSRC as described above, when difference between an estimation time point of a weight index having a maximum transmission rate and a transmission time point using a weight is greater than a coherence time of a fading in environments including a rapid change of the fading due to high speed of a movable body, an incorrect weight may be applied. Therefore, transmission capacity may be greatly reduced. Accordingly, the closed-loop scheme is suitable for data communication of a low speed.

In the aforementioned data communication of the low speed, each data stream multiplied by a weight is transmitted, such that a beam-forming gain can be obtained. Therefore, in the data communication of the low speed, the PSRC provides the beam-forming gain in comparison to the PARC.

Hereinafter, the conventional technology, as described above, will be compared with each other for description. First, because the PARC scheme is an open-loop technology and is not greatly influenced by a temporal correlation of a fading between transmission/reception antennas, the PARC scheme shows a uniform transmission capacity in a relatively wide range of a speed of a terminal. However, because channel condition information of each sub-data stream is fedback, it may be impossible to select a proper channel coding and modulation scheme when a terminal moves at a high speed. Therefore, capacity reduction may occur.

Further, the PARC scheme has a problem in that it experiences great capacity reduction in environments including a high spatial correlation of a channel fading between the transmission/reception antennas.

Because the PSRC scheme transmits a data stream multiplied by a weight and controls a transmission rate according to each data stream, the PSRC scheme provides the beam-forming gain in comparison to the PARC scheme. According to the PSRC scheme, a single transmission/reception system using the beam-forming is operated under an environment including a high spatial correlation, such that the PSRC scheme may not cause great capacity reduction as compared with the PARC scheme. However, because the PSRC scheme is a closed-loop technology, it is necessary to provide weight-related feedback information from a mobile station to a base station, such that the PSRC scheme is not suitable for data communication of high speed.

Further, when the number of transmission/reception antennas increases in order to increase data transmission amount, the amount of information, which must be fedback in a reverse link, may rapidly increase. In such a case, the PSRC scheme has a problem in that it is difficult to apply the PSRC scheme in a mobile communication system including a fading rapidly changing according to passage of time due to movement of a mobile station.

Accordingly, an open-loop multiple transmission/reception antenna technology used in data communication of a wide range is required, in which the open-loop multiple transmission/reception antenna technology is used for a multiple transmission/reception system for transmitting maximum capacity of data under low spatial correlation environments, in which a large spread is observed by a transmitter or a large interval is formed between transmission antennas, and under high SINR environments in which a receiver is adjacent to a transmitter, or used for a single transmission/reception system under high spatial correlation environments in which a small spread is observed by a transmitter or a small interval is formed between transmission antennas and under low SINR environments in which a receiver is remote from a transmitter. That is, it is necessary to research the multiple transmission/reception system capable of minimizing influence by a temporal correlation and a spatial correlation of a channel and maximize capacity of a mobile communication system by flexibly coping with fading channel environments.

PCBRC System

It is assumed herein that a multiple transmission/reception system is a system which includes a transmitter having transmission array antennas in which n_{T} antennas are disposed with an interval d_{T} and a receiver having reception array antennas in which n_{R} antennas are disposed with an interval d_{R}. Further, the number of antennas and an interval between the antennas in each mobile station belonging to a cell or a sector of a base station may be different according to mobile stations. Accordingly, a technology for transmitting multiple data using the multiple transmission/reception system must be applied to various transmission/reception array antenna structures.

PCBRC technology according to an embodiment of the present invention will be described with reference to an example in which the PCBRC technology is applied to a downlink after employing a base station as a transmitter and a mobile station as a receiver. However, the scope of the present invention is not limited to this example. That is, it is noted that the PCBRC technology can be applied to an uplink, after employing the mobile station as the transmitter and the base station as the receiver.

First, the base station determines a weight set (E=[e₁, . . . , eₙ_{_{T}}]) including fixed weight vectors [eₖ(k=1, . . . , n_{T})] corresponding to the number of transmission antennas. The weight set includes column vectors constituting the matrix E. The weights are fixed values, which do not change over time and are commonly applied to all mobile stations in the cell or the sector of the base station.

Further, the weight matrix E is designed to satisfy the following three characteristics.

First, the weight vectors included in the matrix E must be orthogonal between different weights and each weight must have an absolute magnitude of 1 in order to prevent increase of decrease of power in a multiplication process of the weights. The characteristic enables transmit power based on each weight to be equal to each other and to prevent interference between different data beam-formed by each weight from occurring. That is, as the weights are orthogonal to each other as described above, the interference does not occur. This represents that the first condition (orthogonality and magnitude of 1) of the matrix E is an independent condition.

Second, it is necessary to enable power provided to a cell or a sector to be uniform by each weight in consideration of a transmission array antenna structure and a transmission antenna beam pattern (distribution of power dispersed to the sector) of a corresponding base station. This enables power provided to mobile terminals be uniform by each weight when there is no spatial correlation in a downlink fading channel from a base station to one mobile terminal. Herein, the transmission array antenna structure is the number of transmission antennas and an interval between the transmission antennas.

Last, in contrast with a Butler matrix in which one weight exclusively covers a predetermined area in a cell, all areas in the cell must receive power from all weights. The characteristic enables the base station and the mobile terminal to simultaneously transmit and receive a plurality of data streams using a plurality of weights in wireless mobile communication environments including angular spread of signals.

One example of the weight matrix meeting these three characteristics will be described.

First, the weight vectors, which are suitable for environments in which the transmission array antennas including the n_{T} antennas disposed with the interval d_{T} is used in a cell including a sector radius Δ and a radiation pattern P(θ) of a transmission antenna, are obtained by eigenvectors of a transmit spatial correlation matrix shown in Equation (2).

$$R = {\int }_{- Δ / 2}^{Δ / 2} P ( θ ) {a}^{H} ( θ ) a ( θ ) ⅆ θ \qquad ( 2 )$$

In Equation (2), a(θ){=[1exp(j2πd_{T} sin θ/λ) . . . exp(j2π(n_{T}−1)d_{T} sin θ/λ)]} represents an array response vector and is determined by the number of transmission antennas, an interval between the transmission antennas, and a wavelength λ. Equation (3) represents a weight matrix in a cell including a predetermined sector radius and a predetermined transmission antenna radiation pattern, which is symmetrically formed about a broadside when two antennas are disposed at predetermined intervals.

$$E = [ {e}_{1} {e}_{2} ] = [ \begin{matrix}1 / \sqrt{2} & 1 / \sqrt{2} \\ 1 / \sqrt{2} & - 1 / \sqrt{2} \end{matrix} ] \qquad ( 3 )$$

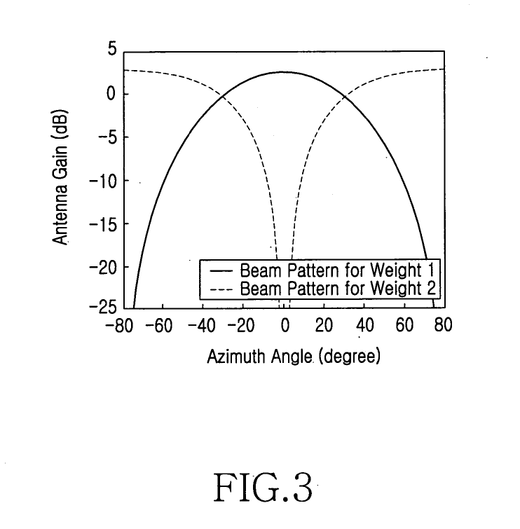

FIG. 3 is a diagram illustrating an example of a beam pattern of a transmit weight matrix in the PCBRC system according to an embodiment of the present invention. FIG. 3 illustrates the beam pattern of the transmit weight matrix when the number of transmission antennas is two and an interval between the transmission antennas is one half wavelength.

Referring to FIG. 3, the three requirement characteristics as described above are satisfied. That is, in order to demodulate traffic data by a reception-side, it is necessary to estimate a downlink fading to a reception antenna of a mobile station from a transmission antenna of a base station. For this, the base station must transmit a pilot channel according to antennas or weights. Herein, because a pilot symbol for estimating the fading or a training sequence is simultaneously transmitted together with traffic data, a general fading estimation scheme used in a mobile communication system is also applied to a multiple transmission/reception antenna system.

Pilot channel transmission for estimating the downlink fading between multiple transmission/reception antennas is performed through the following two schemes.

In a first scheme, orthogonal pilot channels are allocated to each transmission antenna and transmitted, and each reception antenna distinguishes the pilot channels transmitted from different transmission antennas and estimates the corresponding downlink fading. The fading estimated, as described above, may be expressed by a downlink estimation fading matrix H as shown in Equation (4).

$$H = [ \begin{matrix}{h}_{1 , 1} & ⋯ & {h}_{1 , {n}_{T}} \\ ⋮ & ⋮ & ⋮ \\ {h}_{{n}_{R} , 1} & ⋯ & {h}_{{n}_{R} , {n}_{T}}\end{matrix} ] \qquad ( 4 )$$

In Equation (4), h_{r,t} is a fading to an r^{th} reception antenna from a t^{th} transmission antenna. That is, H represents an estimation fading matrix to each reception antenna from each transmission antenna. The mobile station performs an operation as expressed in Equation (5) for a fading estimation to each reception antenna according to each transmission weight on the basis of the estimated value H of the fading between the transmission/reception antennas.

$$\begin{matrix}\overline{H} = HE \\ = [ \begin{matrix}{h}_{1} \\ ⋮ \\ {h}_{{n}_{R}}\end{matrix} ] [ {e}_{1} ⋯ {e}_{{n}_{T}} ] \\ = [ \begin{matrix}{h}_{1} {e}_{1} & ⋯ & {h}_{1} {e}_{{n}_{T}} \\ ⋮ & ⋮ & ⋮ \\ {h}_{{n}_{R}} {e}_{1} & ⋯ & {h}_{{n}_{R}} {e}_{{n}_{T}}\end{matrix} ] \\ = [ \begin{matrix}\overline{{h}_{1 , 1}} & ⋯ & \overline{{h}_{1 , {n}_{T}}} \\ ⋮ & ⋮ & ⋮ \\ \overline{{h}_{{n}_{g} , 1}} & ⋯ & \overline{{h}_{{n}_{R} , {n}_{T}}}\end{matrix} ]\end{matrix} \qquad ( 5 )$$

In Equation (5), because hᵣ represents a downward fading vector to the r^{th} reception antenna from n_{T} transmission antennas, \overline{h}_{r,t} is a downlink fading received to the r^{th} antenna from a t^{th} transmission weight. Accordingly, \overline{H} is a downlink fading matrix to each reception antenna from each transmission weight. In the scheme, the mobile station must know a fixed weight matrix E used in the base station. Herein, because E is fixed, E should be input to the mobile station in advance or E should be received only one time when the mobile station connects to a corresponding base station.

In a second scheme, in contrast with the first scheme, in which the orthogonal pilot channels are allocated to each transmission antenna and transmitted thereto, the orthogonal pilot channels are allocated to each weight. That is, each reception antenna distinguishes the pilot channels transmitted according to different weights and directly estimates the fading matrix \overline{H} to each reception antenna according to each weight. The scheme has an advantage in that it is not necessary to transmit the weight matrix E to the mobile station.

The mobile station determines conditions of each sub-channel formed by each weight vector obtained by a demodulation algorithm used for data demodulation in a corresponding mobile station. The sub-channel is a channel on a space formed through multiplication with each weight, and the number of sub-channel K=min(n_{T},n_{R}) represents a minimum number between the number of transmission antennas and the number of reception antennas and the number of maximum sub-data streams capable of being simultaneously transmitted. Herein, the demodulation algorithm is the general term for an already proposed algorithm such as a Minimum Mean Square Error (MMSE), a Zero Forcing (ZF), a MMSE serial detection, and a ZF serial detection. Herein, the serial detection represents a demodulation algorithm utilizing a Successive Interference Cancellation.

Condition information of each sub-channel may be determined by an SINR, transmittable channel capacity, etc. The determined condition of each sub-channel is reported to the base station by a reverse link feedback channel.

The base station determines power to be supported to each sub-channel, a modulation scheme and a coding rate corresponding to the power by means of the condition information of each sub-channel reported by the mobile station. The allocation of transmit power may be determined by a scheme for maximizing a total sum of all sub-channel capacities on the basis of the condition information of each sub-channel.

The scheme for maximizing the total sum of all sub-channel capacities has been known as a water-filling scheme. Herein, the water-filling scheme is a power allocation scheme for maximizing the capacity when independent data streams are transmitted to each sub-channel of existing multiple sub-channels. In the water-filling scheme, capacity can be maximized by allocating much power to a sub-channel having favorable channel conditions in order to transmit many bits.

That is, much power is allocated to the sub-channel having favorable channel conditions and small power is allocated to a sub-channel having unfavorable channel conditions. When the water-filling provides an optimal power allocation solution in view of an information theory, a scheme for allocating bits and power to each sub-channel based on a combination of an usable channel coding scheme and modulation scheme may be applied in an actual realization. Further, a scheme of allocating the same power to all sub-channels may be considered as a more simple transmit power allocation scheme.

That is, when an SINR of an i^{th} sub-channel is γᵢ, power Pᵢ to be allocated to the i^{th} sub-channel may be determined as expressed in Equation (6) on the basis of the water-filling concept.

$${P}_{i} = max ( ζ - \frac{1}{{r}_{i}} , 0 ) \qquad ( 6 )$$

In Equation (6), ξ is a constant determined to meet

$${\sum }_{i = 1}^{K} {P}_{i} = {P}_{T} .$$

P_{T} is total reception power capable of being used for transmitting traffic data by the base station. Herein, because a sub-channel, in which power allocated by the water-filling becomes zero, occurs in environments having low SINR or high spatial correlation, data is transmitted through only the sub-channel having favorable channel conditions. However, because the above-described process requires an additional feedback for the power allocated to each sub-channel, the scheme of allocating the same power to all sub-channels may be used.

Next, the base station considers the channel condition information for each sub-channel and the power allocated a corresponding sub-channel, and determines a modulation scheme and a coding rate according to the consideration. Herein, various combinations of the modulation scheme and the coding rate may be used according to a mobile communication system, but may be assumed as shown in Table 1.

TABLE 1

| | |
|---|---|
| coding rate | modulation scheme |

No Transmission

| | |
|---|---|
| ½ | QPSK |
| | 8PSK |
| | 16QAM |
| | 64QAM |
| ¾ | QPSK |
| | 8PSK |
| | 16QAM |
| | 64QAM |

In Table 1, it is noted that the ‘no transmission’ representing no-data transmission through the corresponding sub-channel may exist, even if a modulation scheme combination of a smallest bit number per each symbol cannot be used for transmission due to an inferior state of the sub-channel. Accordingly, in the PCBRC system according to the present embodiment, the number of transmittable sub-channels may variously change according to the number of transmission antennas, the number of reception antennas, and the condition of each sub-channel. That is, the number K′ of transmittable sub-channels is obtained by subtracting the number of sub-channels, which belong to the ‘no transmission’, due to the unfavorable channel condition, from the number K of sub-channels, the channel conditions of which are reported by the mobile station. Consequently, the number K′ of finally transmitted sub-channels has a range of K′≦K.

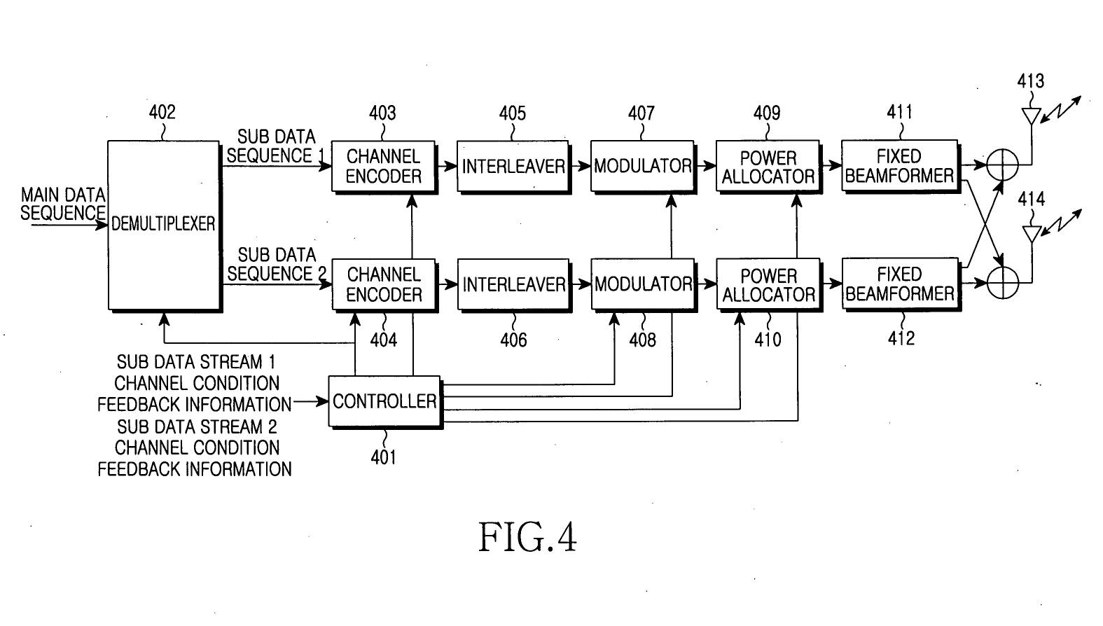

FIG. 4 is a block diagram illustrating a transmitter in a PCBRC system according to an embodiment of the present invention. More specifically, FIG. 4 illustrates a case in which the number of transmission antennas is two. However, the scope of the present invention is not limited to the case in which the number of transmission antennas is two. Further, it is noted that the PCBRC technology according to the present invention can also be applied to general multiple transmission/reception antennas having transmission antennas more than three.

Referring to FIG. 4, in a signal processing procedure of the transmitter according to the present invention, a controller 401 determines the number K′ of finally transmitted sub-channels, power allocated to each sub-channel, a coding rate, and a modulation scheme and power allocation amount for each sub-data stream to be transmitted to each sub-channel by means of the condition information of each sub-channel fedback from the mobile station. Further, the controller 401 informs a demultiplexer 402, channel encoders 403 and 404, modulators 407 and 408, and power allocators 409 and 410 of the determined items. Fixed beam formers 411 and 412 perform a multiplication process of the predetermined weight as described above.

The demultiplexer 402 demultiplexes main data stream to be transmitted to sub-data streams by the number K′ of transmittable sub-channels input from the controller 401. The channel encoders 403 and 404 independently code the each sub-data stream at the determined coding rate, and interleavers 405 and 406 independently interleave the coded streams at the determined coding rate, and the modulators 407 and 408 independently map the interleaved streams according to the modulation scheme.

The power allocators 409 and 410 allocate power to symbols of each sub-data stream and the fixed beam formers 411 and 412 multiply each sub-data stream by a corresponding fixed weight and transmit the multiplication result through transmission antennas 413 and 414. Herein, because a detained description for a beam-forming based on the number K′ of transmittable sub-channels, an adaptive modulation and coding according to the sub-channels, and a fixed weight is as described above, the detained description will be omitted.

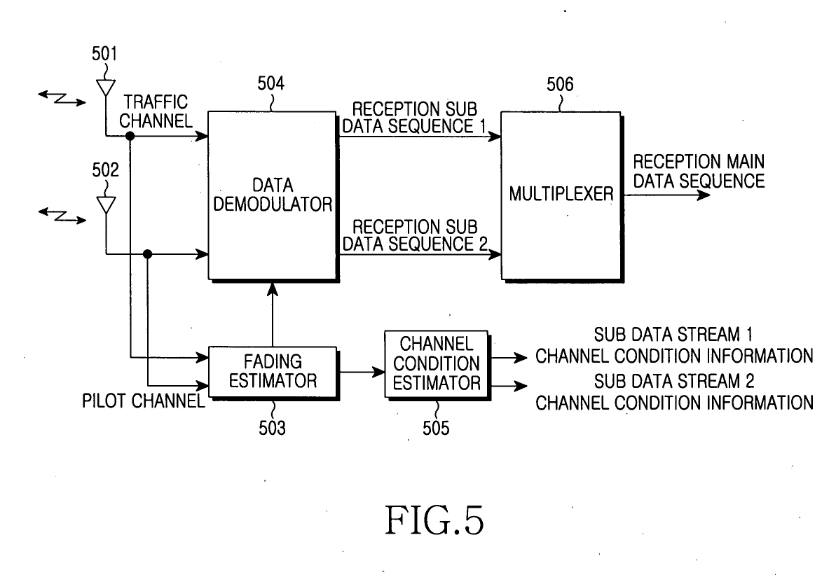

FIG. 5 is a block diagram illustrating a receiver in a PCBRC system according to an embodiment of the present invention. More specifically, FIG. 5 illustrates a case in which the number of reception antennas is two. However, the scope of the present invention is not limited to the case in which the number of reception antennas is two. Further, it is noted that the PCBRC technology according to the embodiment of the present invention can also be applied to general multiple transmission/reception antennas having reception antennas more than three.

Referring to FIG. 5, the receiver may include a fading estimator 503, a data demodulator 504, a channel condition estimator 505 and a multiplexer 506 according to functions. The fading estimator 503 estimates the fading matrix \overline{H} to each reception antenna according to each transmission weight by means of pilot channels or pilot symbols received from a plurality of reception antennas 501 and 502. The data demodulator 504 restores data by means of the estimated fading matrix \overline{H}, and the multiplexer 506 multiplexes the multiple restored sub-data streams to one main data stream. The channel condition estimator 505 is an element for estimating the condition information of each sub-channel using the estimated fading matrix \overline{H}. Herein, the estimated condition information of each sub-channel is fedback to the base station.

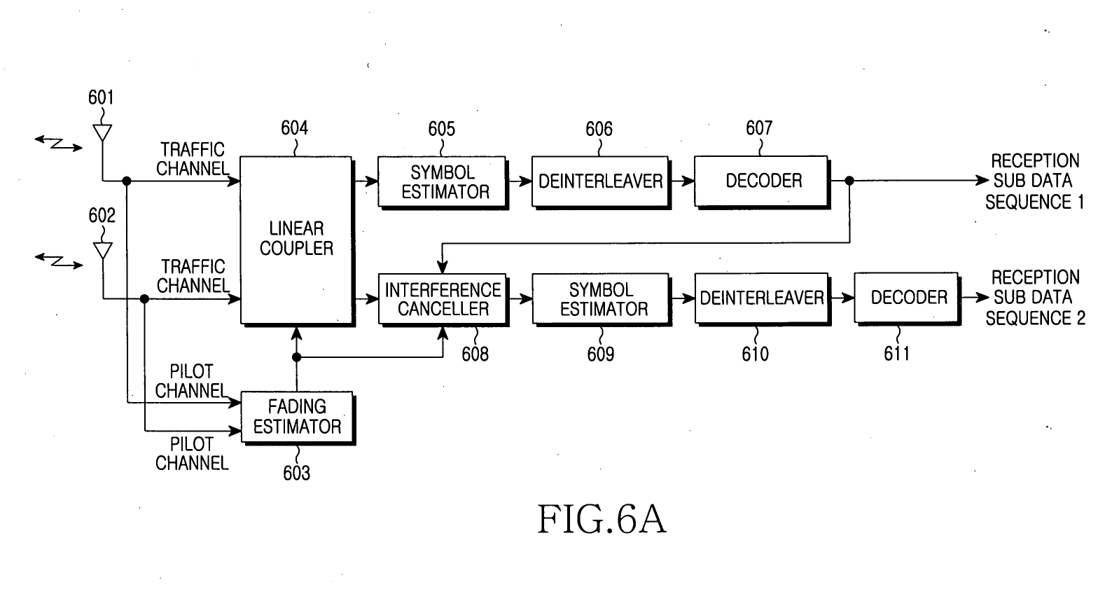

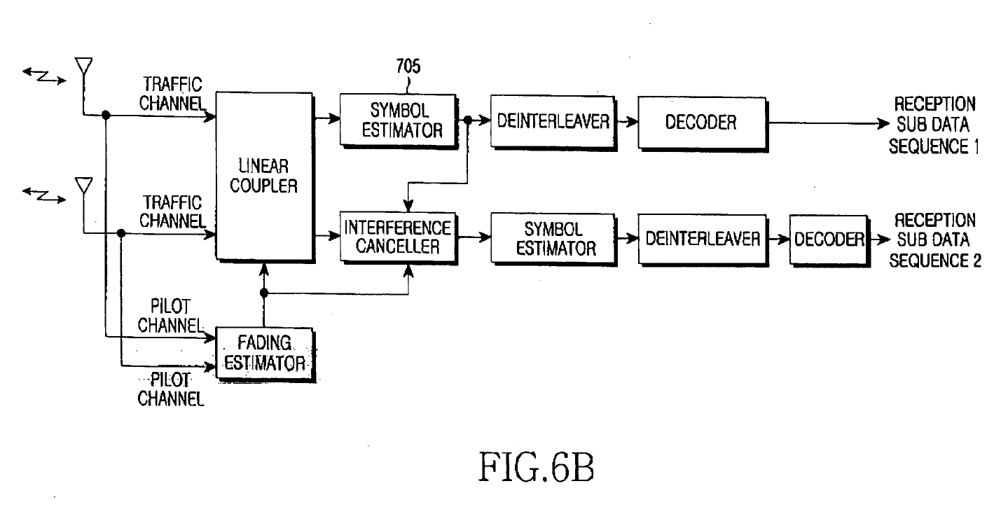

FIGS. 6A and 6B are block diagrams illustrating the data demodulator in the receiver according to embodiments of the present invention. More specifically, FIG. 6A is a block diagram illustrating an embodiment for canceling interference based on a decoded data stream and FIG. 6B is a block diagram illustrating an embodiment for canceling interference based on an estimated symbol.

Referring to FIG. 6A, the data demodulator 504 according to the present invention divides pilot channels from signals received from two reception antennas 601 and 602, and estimates the fading information of multiple transmission/reception antenna channels through a fading estimator 603. The estimated fading information is transferred to a linear coupler 604 and is used for dividing sub-data streams. Herein, a linear coupling scheme may use a well-known linear coupling scheme such as an MMSE and a ZF.

The divided sub-data streams, as described above, have a structure including mutual interference. Herein, in order to occur the mutual interference, in the PSRC scheme, the transmitter adaptively applies the beam-forming. However, the PCBRC scheme according to the present invention uses the fixed beam-forming. Accordingly, a process for canceling the mutual interference as described above is required to improve the performance.

First, a symbol estimator 605 estimates a transmission symbol for a first sub-channel. A first sub-data stream is restored through a deinterleaver 606 and a decoder 607. The data stream restored as described above is used for canceling component functioning as interference in a process of restoring a second sub-data stream.

An interference canceller 608 receives the first sub-data stream and extracts signals including no interference. The interference canceller 608 receives the estimated fading information from the fading estimator 603 in the interference cancellation process. Further, signals output from the interference canceller 608 are used for restoring the second sub-data stream through a symbol estimator 609, a deinterleaver 610, and a decoder 611. Herein, the aforementioned symbol estimator, deinterleaver, and decoder will be referred to as a “data processor”.

FIG. 6B illustrates a construction similar to that shown in FIG. 6A, except that a signal estimated through a symbol estimator 705 is used for the interference cancellation, instead of receiving a first sub-channel signal after the first sub-channel signal has been decoded for the interference cancellation. The detailed description thereof will be omitted.

Hereinafter, an entire control flow performed by the PCBRC receiver will be described with reference to FIGS. 5, 6A, and 6B.

First, the fading estimator 503 estimates the estimated fading matrix \overline{H} of a downlink, i.e., the matrix \overline{H} to each reception antenna from each transmission weight of the transmitter. Herein, when the pilot symbol or the training sequence is used, the fading matrix \overline{H} may be estimated by a general channel estimation scheme used in a mobile communication system.

When the pilot channel is used, an estimation scheme may change according to a pilot channel transmission scheme. First, when each transmission antenna transmits orthogonal pilot channels, the fading matrix H as expressed by Equation (4) to each reception antenna from each transmission antenna is estimated. Then, the fading matrix \overline{H} to each reception antenna according to each transmission weight is estimated through the calculation as expressed in Equation (5) by means of the fixed weight matrix E reported by the base station.

Second, in a scheme of allocating the orthogonal pilot channels to each weight, each reception antenna distinguishes the pilot channels transmitted according to different weights and directly estimates the fading matrix \overline{H} to each reception antenna according to each weight.

The estimated fading matrix \overline{H}, which is estimated by the fading estimator, may mainly be used for two purposes. In the first purpose, the estimated fading matrix \overline{H} may be used for demodulating multiple data streams transmitted from the data demodulator 504. That is, the multiple data streams transmitted through the PCBRC transmission technology may be restored through all existing demodulation algorithms. Hereinafter, a receiver executing an MMSE serial detection algorithm will be described as one example for describing the operation of the receiver according to the present invention.

First, MMSE weight vectors are calculated for K′ sub-data streams using the estimated fading matrix \overline{H}, and SINRs of the K′ sub-data streams are calculated using each MMSE weight vector. A symbol of a sub-data stream having a maximum SINR is first estimated from among the K′ sub-data streams, and is decoded, such that first data are restored.

Thereafter, in order to restore a second data stream, the first restored data are encoded again and are subjected to a symbol mapping by a corresponding modulation scheme. The mapped data are multiplied by a corresponding fading vector and subtracted from a received signal.

A portion for already estimated first data is removed through the process, so that interference caused by the previously estimated data can be cancelled in the next data estimation. Further, the series of continuous estimation and interference cancellation processes are repeated until all of the K′ data streams are restored. Accordingly, data of the K′ sub-data streams can be restored through the aforementioned demodulation process.

The fading matrix \overline{H} estimated by the fading estimator 503 is used when the channel condition estimator 505 estimates channel conditions of a spatial sub-channel formed by each transmission weight. Herein, the number K of sub-channels, the channel conditions of which are estimated, is min(n_{T},n_{R}). When the SINR is used as the condition information of each sub-channel, the following estimation is performed.

The channel conditions of each sub-channel are estimated by means of the reception algorithm equal to that used in the demodulator 504. Further, MMSE weight vectors for the K sub-channels using the estimated fading matrix \overline{H} and SINRs of the K sub-channels are calculated using each MMSE weight vector. An SINR of a sub-channel having a maximum SINR from among the K sub-channels is calculated and the calculated SINR is stored as condition information of a corresponding sub-channel. Herein, a portion caused by a pilot channel of the already estimated sub-channel is removed, MMSE weights are calculated for remaining (K−1) sub-channels, and an SINR of a sub-channel having a maximum SINR. The calculated SINR is stored as condition information of a corresponding sub-channel.

The series of continuous estimation and interference cancellation processes are repeated until SINRs for all of the K sub-channels are calculated, and the SINRs for the K sub-channels are calculated through the process. The estimated condition information of each sub-channel is transferred to a base station through a reverse link feedback channel. The condition information of each sub-channel is used when the transmitter of the base station determines the number K′ of finally transmittable sub-channels, allocation power of each sub-channel, and a coding rate and a modulation scheme of each sub-data stream to be transmitted to each sub-channel.

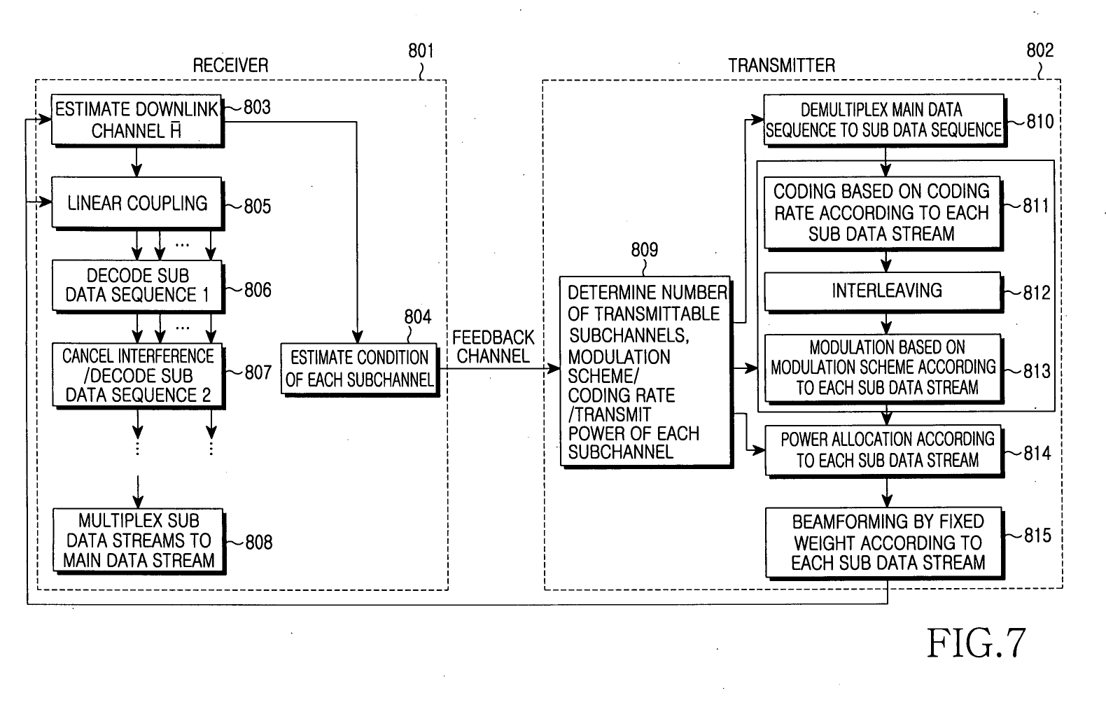

FIG. 7 is a block diagram illustrating a transmission/reception operation process of a PCBRC system according to an embodiment of the present invention. Referring to FIG. 7, a receiver 801 transmits condition information of each sub-channel to a transmitter 802 through a feedback channel, and the transmitter 802 transmits a data stream to the receiver 801. The receiver 801 estimates a fading of multiple transmission/reception antenna channels in step 803, estimates conditions of each sub-channel in step 804, and transmits the estimated conditions to the transmitter 802. Further, the receiver 801 linearly couples a signal received through a fading of an estimated channel in step 805, divides the signals according to sub-channels, and decodes each sub-data stream in steps 806 and 807. Herein, the previously decoded sub-data stream is used for canceling interference in a decoding process of a sub-data stream, which will be decoded later. This interference cancellation and sub-data stream decoding process is continued until all of the transmitted data streams are restored. When all data streams are restored, the data streams are multiplexed to provide a main data stream in step 808.

The transmitter 802 determines the number of transmittable sub-channels, and a modulation scheme, a coding scheme and transmit power of each sub-channel through the condition of each sub-channel transmitted from the receiver 801 in step 809. In step 810, the transmitter 802 demultiplexes a main data stream to sub-data streams based on the determined items. Further, the demultiplexed sub-data streams independently passes through an encoding process in step 811, an interleaving process in step 812, and a modulation process in step 813. The power allocation according to the sub-channel already determined in step 809 is applied to each of the independently coded sub-data streams as described above in step 814. Thereafter, each sub-data stream is beam-formed by means of a fixed weight having been preset between the transmitter and the receiver in step 815, and then transmitted.

Hereinafter, a preferred operating process of the present invention according to various transmission/reception array antenna structures as described above will be described.

First, it is assumed that there is a multiple transmission/reception system which includes a base station having a transmission array antenna in which (n_{T}>1) transmission antennas are disposed with an interval d_{T} and a mobile station having a reception array antenna in which n_{R} reception antennas are disposed with an interval d_{R}.

The operation process of the present invention when the n_{R}=1, that is, one reception antenna exists in the mobile station will be described.

The base station transmits pilot channels using n_{T} fixed weights. The mobile station selects one sub-channel {K=min(n_{T},1)=1} transferring the highest SINR from among sub-channels formed by the n_{T} fixed weights, and feeds back conditions of the selected sub-channel to the base station. The base station determines a modulation scheme, a coding rate, and power allocation according to the fedback conditions of the corresponding sub-channel, and transmits a data stream. Herein, the operation as described above is performed per each time slot so as to provide a fixed beam selection diversity for selecting a beam transferring maximum power from among fixed beams in variable fading channel environments.

Second, the operation process of the present invention when the n_{R}>1, that is, multiple reception antennas exist in the mobile station will be described.

The base station transmits pilot channels by means of n_{T} fixed weights. The mobile station selects {K=min(n_{T}, n_{R})} sub-channels transferring the highest SINR from among sub-channels formed by the n_{T} fixed weights, and feedbacks conditions of the K sub-channels to the base station. The base station determines the number K′ of transmittable sub-channels, and a modulation scheme, i.e., a coding rate and allocation power of each sub-channel according to the fedback conditions of the K sub-channels.

Herein, when the number K′ of finally transmittable sub-channels is determined to be 1 in environments having a high spatial correlation of a downlink fading and a low SINR, a single data stream multiplied by a corresponding weight is transmitted through corresponding one sub-channel. The operation as described above is performed to provide a fixed beam selection diversity for selecting the beam transferring the maximum power from among the fixed beams, similarly to the case including one reception antenna.

In environments having a low spatial correlation and a high SINR, the number K′ of finally transmittable sub-channels is greater than 1, a plurality of sub-data streams are symbolized through each coding rate and modulation scheme, and corresponding power is allocated. A plurality of sub-data streams are transmitted after multiplying the sub-data streams by a corresponding weight thereof. In this case, multiple transmission/reception antenna systems capable of transmitting a plurality of data streams can be realized.

As described above, in a data transmission/reception apparatus adaptive to channel conditions having various temporal and spatial correlations according to an embodiment of the present invention, a base station constructs orthogonal spatial sub-channels using fixed transmission weights, and adjusts transmit power and a transmission rate of each data stream transmitted through each sub-channel according to conditions of each sub-channel. Accordingly, the base station estimates the conditions of each sub-channel formed by the transmission weights of the base station and feeds back the estimated result to the base station.

Herein, in environments having a low spatial correlation, average power transferred through each sub-channel is uniform. However, when the spatial correlation increases, difference between average power transferred through each sub-channel also increases. Accordingly, as the spatial correlation in mobile communication environments increases, power is concentrated on a small number of sub-channels. In the situation as described above, when considering condition information of each sub-channel fedback to the base station, SINRs of the small number of sub-channels are considerably greater than those of other sub-channels.

Herein, transmit power is not allocated to a sub-channel having a very low SINR or data is not transmitted through an adaptive modulation encoder. However, high transmit power is allocated to a sub-channel having a high SINR and data are transmitted using a modulation scheme of a high transmission rate and a high coding rate. Therefore, system capacity can be maximized.

Accordingly, in environments having a high spatial correlation, a scheme of transmitting data through one sub-channel based on one weight is realized, that is, it is possible to realize a single data stream transmission system employing a beam-forming process. In the environments having the high spatial correlation as described above, a beam-forming scheme provides capacity similar to maximum transmittable capacity.

In contrast, in environments having a low spatial correlation, average power transferred through each sub-channel is uniform and a fading correlation between sub-channels is reduced. Accordingly, it is possible to realize multiple data stream transmission systems simultaneously transmitting multiple data through a plurality of sub-channels.

The technical characteristics of the present invention as described above may be summarized as follows.

The present invention is adaptively used for a beam-forming system capable of transmitting maximum power by means of a single fixed weight, that is, a transmission/reception system capable of transmitting a single data stream, in environments having the high spatial correlation of a fading between transmission/reception antennas, or used for multiple data stream transmission/reception systems using a plurality of fixed weights in environments having the low spatial correlation of the fading between transmission/reception antennas. That is, the present invention enables maximum data capacity to be transmitted in predetermined channel environments by adaptively operating according to the spatial correlation of the channel.

Further, because the transmission weights used in the base station are fixed and predetermined weights, which are optimized in a transmission array antenna structure and a cell structure of the base station, are used, it is not necessary for each mobile station to feedback information relating to weights for beam-forming of each sub-data stream to the base station.

Herein, because a magnitude and a phase of the weight is influenced, when the weight information is fedback, overhead from the feedback greatly increases. Accordingly, a PCBRC technology proposed by the present invention enables low overhead to occur in comparison to the typical a PSRC scheme. Further, it is possible to easily realize a multiple transmission/reception antenna system including three or more transmission/reception antennas. Furthermore, it is possible to prevent capacity reduction caused by a fast fading even in environments including high speed of a mobile station.

Additionally, the PCBRC technology proposed by the present invention enables a beam-forming system or multiple transmission/reception systems to be adaptively realized according to average intensities or SINRs of signals received in the mobile station from the base station. In particular, when the mobile station exists in environments not being suitable for receiving the signals from the base station, the PCBRC technology is used for the beam-forming system, such that transmission capacity can be maximized.

As described above, the present invention relates to multiple transmission/reception antenna technologies capable of being used in data communication of a wide range. Accordingly, the present invention is used for multiple transmission/reception systems under environments having a low spatial correlation or high SINR, or used for a single transmission/reception system including a beam-forming gain under environments having a high spatial correlation or low SINR, according to fading channel environments. That is, the present invention minimizes an influence by a temporal correlation and a spatial correlation of a channel, and maximizes capacity by flexibly handling different channel environments.

According to an apparatus and a method for transmitting/receiving data in a mobile communication system including an array antenna of the present invention, it is possible to increase capacity of the mobile communication system in fading environments including various temporal and spatial correlation characteristics.

Further, according to the present invention, a base station constructs orthogonal spatial sub-channels using fixed transmission weights, and adjusts transmit power and a transmission rate of a data stream transmitted through each sub-channel according to conditions of each sub-channel, such that it is possible to adjust the number of sub-channels transmitting data according to a spatial correlation in operated environments and an average reception SINR in a mobile station.

Furthermore, according to the present invention, in environments having a high spatial correlation and low SINR, it is possible to realize a beam-forming system based on a single weight, that is, a single data stream transmission system. Further, in the environments having a low spatial correlation and high SINR, it is possible to realize a system for simultaneously transmitting a plurality of data streams through a plurality of sub-channels formed by a plurality of weights. Therefore, it is possible to adjust the number of sub-channels adaptively transmitting the data according to the spatial correlation in the environments. Accordingly, it is possible to transmit capacity similar to maximum capacity capable of being transmitted through a corresponding fading channel.

Furthermore, according to the present invention, the need for feeding back a plurality of weight information for transmitting a plurality of data streams from each mobile station to a base station is removed using fixed common transmission weights optimized in a transmission array antenna structure and a cell structure of a base station. Therefore, it is possible to prevent system capacity from being reduced due to weight feedback delay even in fast fading environments and to easily realize multiple transmission/reception antenna systems including three or more transmission/reception antennas.

Furthermore, the present invention proposes new multiple transmission/reception antenna technologies, which can be used in data communication of a wide range, are used for multiple transmission/reception systems under environments having a low spatial correlation or high SINR, or used for a single transmission/reception system including a beam-forming gain under environments having a high spatial correlation or low SINR, according to condition of a fading channel between transmission/reception antennas. Therefore, the present invention minimizes the influence by a temporal correlation and a spatial correlation of a channel and maximize capacity of a mobile communication system by flexibly handling fading channel environments.

Although preferred embodiments of the present invention have been described for illustrative purposes, those skilled in the art will appreciate that various modifications, additions, and substitutions are possible, without departing from the scope and spirit of the present invention as disclosed in the accompanying claims, including the full scope of equivalents thereof.

1. A method of transmitting data by dividing the data into sub-data streams in a mobile communication system having a multiple array antenna, the method comprising the steps of:
transmitting pilot channels through a transmission antenna while aligning the pilot channels orthogonally to each other;
receiving feedback information related to the pilot channels from a mobile station capable of receiving the data;
dividing the data to be transmitted into the sub-data streams using the feedback information;
determining a coding rate and a transmit power for the sub-data streams;
converting the sub-data streams into symbol arrays to be transmitted according to the coding rate and the transmit power; and
transmitting data by converting the data into fixed beams.

2. The method as claimed in claim 1, wherein each of the pilot channels is allocated to each of transmission antennas when transmitting the pilot channels.

3. The method as claimed in claim 1, wherein each of the pilot channels is applied to each weight of transmission antennas when transmitting the pilot channels.

4. The method as claimed in claim 1, wherein the feedback information related to the pilot channels includes values obtained according to a temporal correlation and a spatial correlation of a channel environment.

5. The method as claimed in claim 4, wherein the temporal correlation of the channel environment is a signal to interference plus noise ratio (SINR) measured in the mobile station.

6. The method as claimed in claim 4, wherein the data to be transmitted is divided into the sub-data streams using the feedback information in such a manner that a transmittable sub-data stream has a maximum value.

7. The method as claimed in claim 1, wherein the transmit power is allocated to the sub-data streams of the data to be transmitted using a water-filling scheme based on the feedback information.

8. The method as claimed in claim 1, wherein a same transmit power is allocated to each of the sub-data streams of the data to be transmitted based on the feedback information.

9. An apparatus for transmitting data by dividing the data into sub-data streams in a mobile communication system having a multiple array antenna, the apparatus comprising:
a controller for receiving feedback information related to the pilot channels from a mobile station capable of receiving the data, determining a number and a size of the sub-data streams of the data to be transmitted using the feedback information, and determining and outputting a coding rate and a transmit power for the sub-data streams;
a demultiplexer for demultiplexing the data according to information related to the number and the size of the sub-data streams transmitted from the controller, and for outputting the data to the mobile station;
a data processing unit for receiving the coding rate from the controller, converting the sub-data streams output from the demultiplexer into symbols to be transmitted, and outputting the symbols;
a power allocating unit for receiving power allocation information from the controller, allocating power to each symbol transmitted thereto from the data processing unit, and outputting the symbols; and
a fixed beam former for performing a beam-forming process in order to convert the symbols output from the power allocating unit into predetermined beams.

10. The apparatus as claimed in claim 9, wherein the controller controls the pilot channels, which are orthogonal to each other, such that each of the pilot channels is allocated to each of transmission antennas, when the pilot channel is transmitted, in order to receive the feedback information from each mobile station.

11. The apparatus as claimed in claim 9, wherein the controller applies the pilot channels, which are orthogonal to each other, to weights of transmission antennas when transmitting the pilot channels.

12. The apparatus as claimed in claim 9, wherein the feedback information includes values obtained according to a temporal correlation and a spatial correlation of a channel environment.

13. The apparatus as claimed in claim 9, wherein the controller divides the data to be transmitted into sub-data streams using the feedback information in such a manner that a transmittable sub-data stream has a maximum value.

14. The apparatus as claimed in claim 9, wherein the controller allocates the transmit power to the sub-data streams of the data to be transmitted using a water-filling scheme based on the feedback information.

15. The apparatus as claimed in claim 9, wherein the controller allocates a same transmit power to each sub-data stream of the data to be transmitted based on the feedback information.

16. A method of receiving data, that is transmitted after being divided into sub-data streams, in a mobile communication system having a multiple array antenna, the method comprising the steps of:
estimating a state of each of sub-channels established by a multiple antenna of a transmitter;
feeding back information related to the state each of the sub-channels;
determining a decoding order of data streams received in each of the sub-channels;
sequentially decoding the data streams according to the decoding order;
removing interference of decoded data streams to the data streams being decoded; and
multiplexing the sub-data streams into a main data stream when a decoding process for the data streams has been completed.

17. The method as claimed in claim 16, wherein the interference of the decoded data streams to the data streams being decoded is removed using a decoded symbol.

18. The method as claimed in claim 16, wherein the interference of the decoded data streams to the data streams being decoded is removed using a symbol that has been estimated per each sub-data stream.

19. An apparatus for receiving data, which is transmitted after being divided into sub-data streams, in a mobile communication system having a multiple array antenna, the apparatus comprising:
a fading estimator for estimating a fading of each of sub-channels established by a multiple antenna of a transmitter;
a channel state estimator for creating channel state information for each sub-data stream and feeding back the channel state information by using a signal output from the fading estimator;
a linear coupler for outputting data by linearly combining sub-data streams received through the multiple array antenna;
a data processing unit for decoding sub-data streams, which are output from the linear coupler and in which interference is not removed;
an interference remover for removing interference caused by decoded information based on information output from the data processing unit and the fading estimator; and
a data processing unit for decoding sub-data streams output from the interference remover.

20. The apparatus as claimed in claim 19, wherein the data processing unit comprises:
a symbol estimator for estimating a symbol of the sub-data stream to be decoded;
a deinterleaver for deinterleaving an estimated symbol; and
a decoder for decoding a deinterleaved symbol.

21. The apparatus as claimed in claim 20, wherein an output from the data processing unit to the interference remover is output from the decoder.

22. The apparatus as claimed in claim 20, wherein an output from the data processing unit to the interference remover is output from the symbol estimator.

23. The apparatus as claimed in claim 19, wherein, when at least three sub-data streams are received, a number of the interference removers is increased according to:
N=n−2,
where N is an increased number of the interference removers and n is a number of the sub-data streams, and a number of the data processing unit for decoding the sub-data streams output from the interference remover is increased corresponding to the number of the interference removers.
